(19) United States
(12) Patent Application Publication
(10) Pub. No.: US 2004/0239669 A1
(43) Pub. Date: Dec. 2, 2004

(54) Method for video image display on a display device for correcting large zone flicker and consumption peaks

(76) Inventors: Didier Doyen, La Bouexiere (FR); Herbert Hoelzemann, Merkelbach (DE); Jonathan Kervec, Geveze (FR)

Correspondence Address: Joseph S Tripoli, Thomson Licensing Inc, PO Box 5312, Princeton, NJ, 08543-5312, US

(21) Appl. No.: 10/491,209

(22) PCT Filed: Sep. 20, 2002
(86) PCT No.: PCT/FR02/03214

(30) Foreign Application Priority Data
Sep. 26, 2001 (FR) 01/12588

(51) Int. Cl. G06T 1/00

(52) U.S. Cl. 345/418

(57) ABSTRACT

The present invention relates to a method of displaying video images on a digital display device. The display frame of an image comprises periods for addressing the odd row cells and the even row cells of the device separately and periods for erasing them separately. Each subfield of the video frame comprises at least one address period, one erase period and at least one sustain period. The periods are arranged among themselves so as to obtain an arrangement of the subfields in the video frame or a temporal position of the video frame which is different for the odd rows and the even rows of the device. Preferably, the device is a plasma display panel.

The present invention relates to a method of displaying video images on a display device. The invention is most particularly intended to correct the display defects produced by display panels having cells operating in on/off mode, especially plasma display panels, namely large-area flicker effects and contouring effects, and to reduce the amplitude of current consumption peaks which appear when a video image is being displayed.

The technology of plasma display panels (hereafter called PDPs) allows large flat display screens to be obtained. PDPs generally comprise two insulating tiles that define between them a gas-filled space in which elementary spaces bounded by barrier ribs are defined. Each tile is provided with one or more arrays of electrodes. An elementary cell corresponds to an elementary space provided on each side of the said elementary space with at least one electrode. To activate an elementary cell, an electrical discharge is produced in the corresponding elementary space by applying a voltage between the electrodes of the cell. The electrical discharge then causes the emission of UV rays in the elementary cell. Phosphors deposited on the walls of the cell convert the UV rays into visible light.

The operating period of an elementary cell of a PDP corresponds to the display period of a video image, called a video frame. Each video frame is composed of several elementary periods commonly called subfields. Each subfield comprises an address period, a sustain period and an erase period. The addressing or turning-on of a cell consists in sending or not sending an electrical pulse of high amplitude into the cell in order to place the latter in the on state or off state. The cell is kept in this state by sending a succession of lower pulses over the sustain period. Each subfield has a specific sustain period duration and a weight which depends on the duration of its sustain period. The cell is erased or turned off by cancelling the electrical charges inside the cell by means of a damped discharge. The illumination periods of the cell correspond to the sustain periods of the cell. These periods are distributed over the entire video frame. The human eye then performs an integration of these illumination periods in order to recreate the corresponding grey level.

There are a few problems associated with the temporal integration of the illumination periods. The problem of large-area flicker may occur in uniform regions of the image having a high grey level. This is because the frame frequency of current displays (cathode-ray tube or plasma displays) is equal to 50 Hz. Given that this frequency is relatively low (less than 60 Hz) for the human eye, the latter perceives a flicker in the regions of high video level. This is because, in the case of a video frame having eight subfields of respective weights 1, 2, 4, 8, 16, 32, 64 and 128, the address periods occupy approximately 70% of the video frame compared with 30% for the sustain periods. A grey level of 255 is obtained by turning on all the subfields of the video frame. The video information is then spread over the entire video frame. However, in terms of luminous intensity, most of the luminous information (224/255, i.e. 87%) is displayed during the three high-weight subfields (i.e. 43% of the video frame=2/8 of 70%+87% of 30%). Because of this concentration and the presence of a white screen, the human eye will detect intensity peaks every 20 ms (50 Hz) and will therefore perceive a flicker.

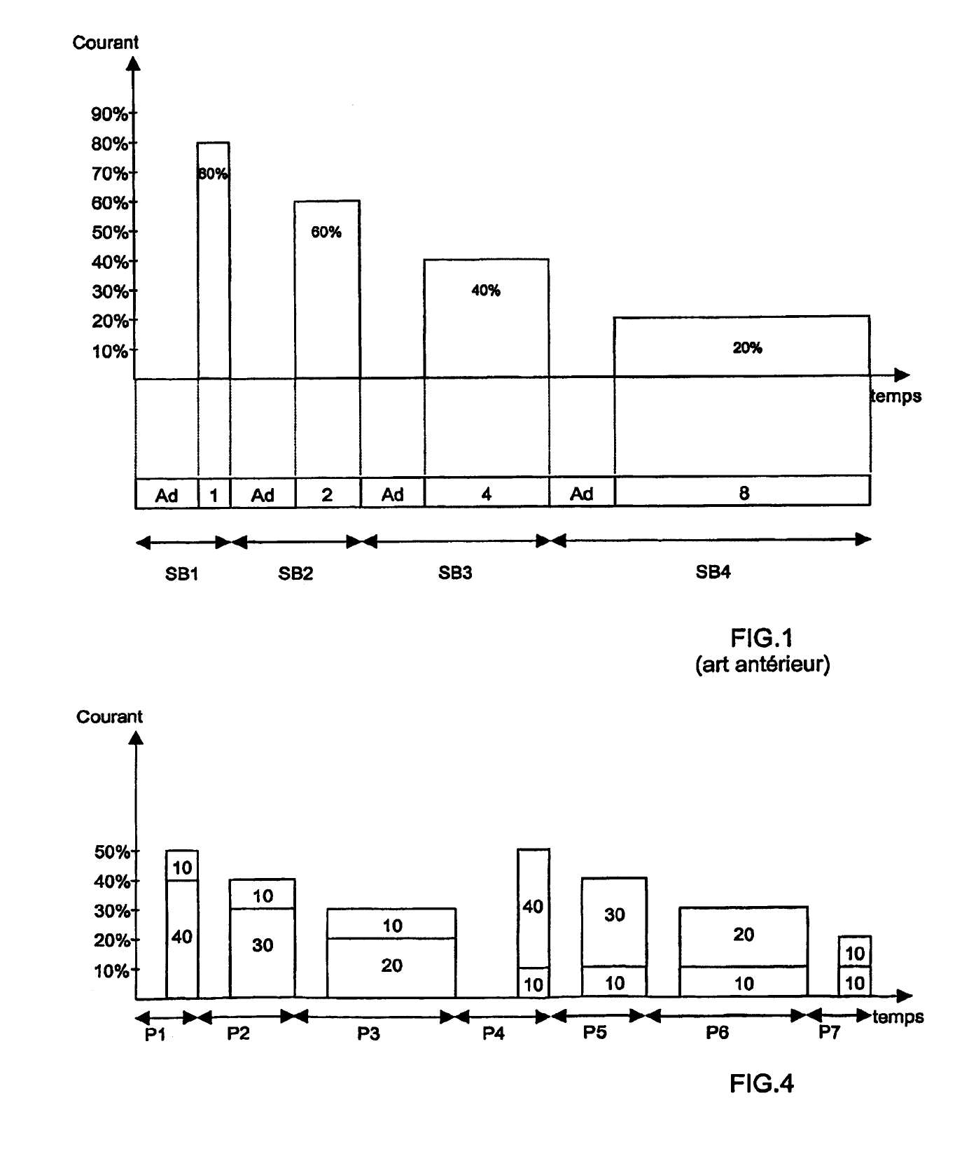

Moreover, as regards the current consumption by the PDP, current peaks generally appear during the low-weight subfields which are the subfields that are most often on. This phenomenon is more particularly present in the case of incremental encoding in which, for all the grey levels apart from the 0 grey level, the lowest-weight subfield is always on. It will be recalled that, in incremental encoding, the cells change state at most once during the video frame. If a cell is in the on state at the start of a frame and switches into the off state during a subfield of this video frame, it remains in this state until the end of the video frame. As a result, most of the cells are on during the low-weight subfields of the video frame and the current consumption during these subfields is therefore higher. This problem is illustrated through the example of an incremental code comprising four subfields SF1 to SF4 having respective weights of 1, 2, 4 and 8. It will also be considered that an image has an equiprobable random distribution of grey levels (20% of the cells have a grey level of 0; 20% of the cells are on only during the subfield SF1; 20% of the cells are on only during the subfields SF1 and SF2; 20% of the cells are on only during the subfields SF1, SF2 and SF3 and 20% of the cells are on during the four subfields SF1, SF2, SF3 and SF4). The energy consumed by the PDP while this image is being displayed is shown in FIG. 1. In this figure, the 100% percentage value is considered to correspond to the intensity of the current to be delivered to the PDP when all of the cells of the PDP are on at the same time, called maximum current intensity. FIG. 1 shows that the supply circuit of the PDP must deliver a current whose intensity is equal to 80% of the maximum current intensity during the sustain period of the subfield SF1, equal to 60% of the maximum current intensity during the sustain period of the subfield SF2, equal to 40% of the maximum current intensity during the sustain period of the subfield SF3 and equal to 20% of the maximum current intensity during the sustain period of the subfield SF4.

An object of the invention is to eliminate large-area flicker. Another object of the invention is to reduce the intensity of the current to be delivered to the PDP during the low-weight subfields of the video frame.

The invention is a method of displaying a video image on a display device during a video frame. The said device comprises a plurality of cells arranged in rows and columns. The video frame is composed of a plurality of periods called subfields during which each elementary cell is either in the on state or in the off state for a time proportional to an illumination weight. Each subfield comprises:

an odd or even address period for addressing the odd row cells or the even row cells, respectively;

at least one sustain period, common to all of the cells of the panel, during which the cells are on or off depending on the last addressing; and

an even or odd erase period in order to erase the state of the odd row cells and of the even row cells, respectively.

At least one subfield associated with the odd rows has at least two sustain periods separated by at least one even sustain period and/or one even erase period. At least one subfield associated with the even rows has at least two sustain periods separated by at least one odd sustain period and/or one odd erase period. The method splits, for the odd and even rows of the panel, the subfields into two groups of subfields, the first group comprising the low-weight subfields and the second group comprising the high-weight subfields, both groups having approximately equal durations. Then, the movement of the current video image with respect to a previous video image is estimated so as to generate a movement vector for each pixel of the current video image. For each pixel of the current video image, the subfields of one of the groups for the even rows of the panel and the subfields of the other of the groups for the odd rows are displaced by an amount approximately equal to half of the estimated movement vector. According to a first embodiment, the subfields of the video frame of the even rows of the panel are displayed in the same order as those of the odd rows of the panel, but they are temporarily offset by approximately half a video frame with respect to the latter. Either, for each pixel of the current video image, the subfields of the second group for the odd rows of the panel and the subfields of the first group for the even rows of the panel are displaced by an amount approximately equal to half of the estimated movement vector and the subfields of the second group for the even rows of the panel are displaced by an amount approximately equal to the estimated movement vector. Or, for each pixel of the current video image, the subfields of the second group for the even rows of the panel and the subfields of the first group for the odd rows of the panel are displaced by an amount approximately equal to half of the estimated movement vector and the subfields of the second group for the odd rows of the panel are displaced by an amount approximately equal to the estimated movement vector.

According to a second embodiment, the high-weight subfields of the even rows of the panel are, for the same image, displayed during the low-weight subfields of the odd rows, and vice versa. Either, for each pixel of the current video image, the subfields of the second group for the odd rows of the panel and the subfields of the first group for the even rows of the panel are displaced by an amount approximately equal to half of the estimated movement vector. Or, for each pixel of the current video image, the subfields of the second group for the even rows of the panel and the subfields of the first group for the odd rows of the panel are displaced by an amount approximately equal to half of the estimated movement vector.

The invention is also a plasma display panel which includes a device for implementing the display method of the invention.

Further features and advantages of the invention will become apparent on reading the detailed description which follows, given with reference to the appended drawings in which:

FIG. 1, already described, shows the energy that the PDP supply circuit must deliver during a video frame with a method of the prior art;

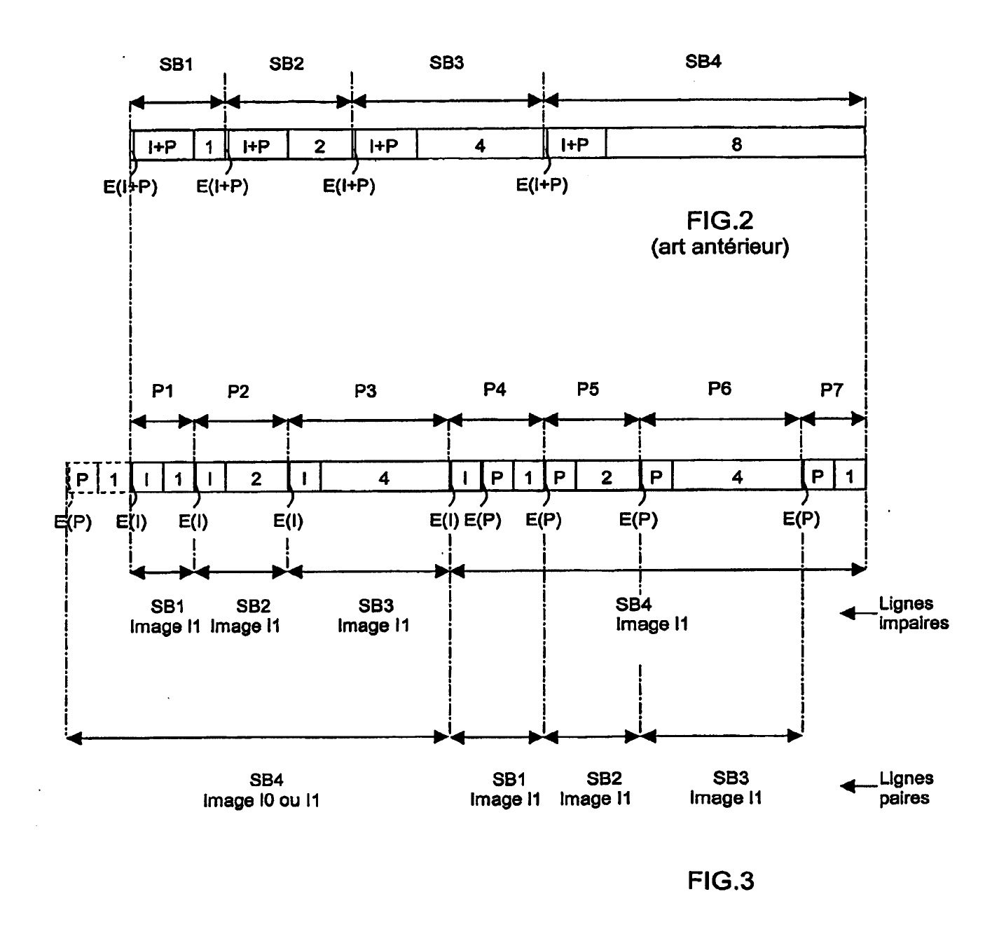

FIG. 2 shows the composition of the video frame of the display method of the prior art;

FIG. 3 shows the composition of the video frame of the display method according to the invention;

FIG. 4, to be compared with FIG. 1, shows the energy that the PDP supply circuit must deliver during a video frame according to the method of the invention;

FIG. 4 illustrates a first mode of implementation of the method of the invention with movement compensation;

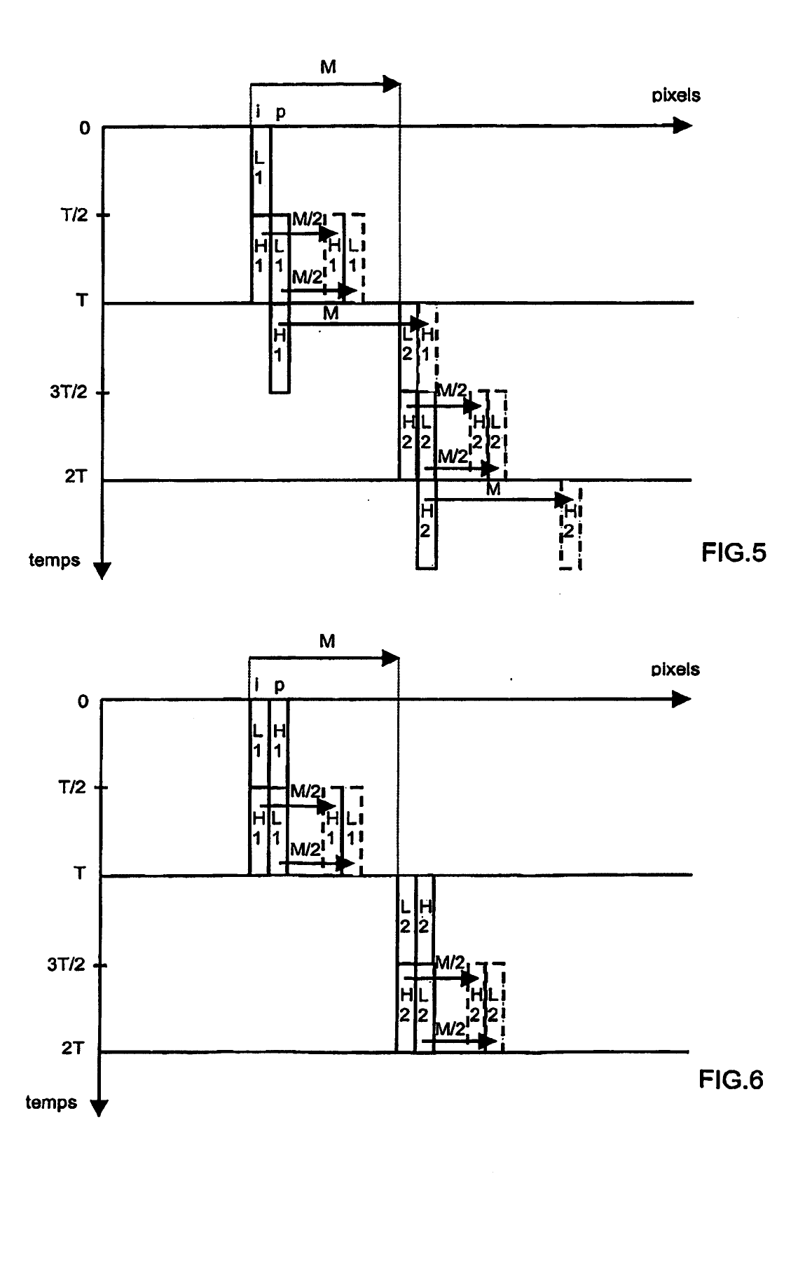

FIG. 6 illustrates a second mode of implementation of the method of the invention with movement compensation;

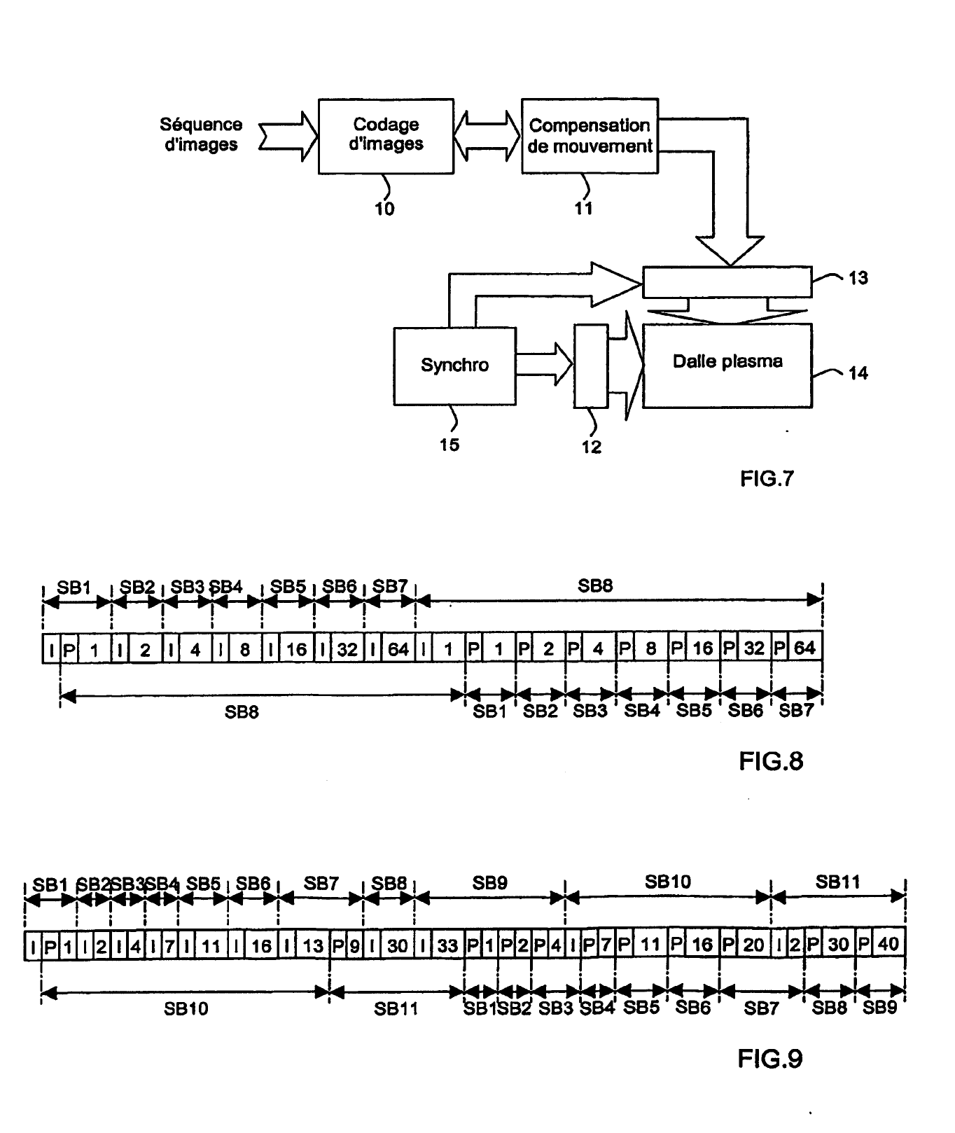

FIG. 7 shows an example of a device for implementing the method of the invention; and

FIGS. 8 and 9 show alternative ways of splitting the grey levels.

According to the invention, the addressing of the cells of the odd rows of the PDP is separated from the addressing of the cells of the odd rows. The same applies to the erasing of the cells. The display frame of a video image consequently comprises periods I for addressing the cells of the odd rows of the PDP, periods P for addressing the cells of the even rows of the PDP, periods E(I) for erasing the cells of the odd rows of PDP, periods E(P) for erasing the cells of the odd rows of the PDP and sustain periods common to all the cells of PDP. This novel structure of the video frame is illustrated through FIG. 3, to be compared with FIG. 2 which shows a video frame structure of the prior art.

FIG. 2 shows a video frame comprising four subfields SF1, SF2, SF3 and SF4 of respective weights 1, 2, 4 and 8. Each subfield has an erase period E(I+P) during which all the cells of the even and odd rows of the PDP are erased sequentially, an address period I+P during which all the cells of the even and odd rows of the PDP are addressed sequentially and a sustain period, the duration of which is proportional to the weight of the subfield in question. The rows of the PDP are addressed one after the other, that is to say an odd row, then an even row, then an odd row, and so on.

FIG. 3 shows, as indicated above, that the display frame of a video image according to the invention comprises periods I and P for addressing the odd row and even row cells of the PDP respectively, periods E(I) and E(P) for erasing the odd and even row cells of the PDP respectively, and sustain periods which are common to all the cells of the PDP. The sustain period of the subfield SF4 of weight 8 is split into four sustain periods of shorter duration, namely into two sustain periods of weight 1, one sustain period of weight 2 and one sustain period of weight 4. The video frame in FIG. 3 then has eight elementary periods:

a first period P1 comprising an erase period E(I), an address period I and a sustain period of weight 1;

a second period P2 comprising an erase period E(I), an address period I and a sustain period of weight 2;

a third period P3 comprising an erase period E(I), an address period I and a sustain period of weight 4;

a fourth period P4 comprising an erase period E(I), an address period I, an erase period E(P), an address period P and a sustain period of weight 1;

a fifth period P5 comprising an erase period E(P), an address period P and a sustain period of weight 2;

a sixth period P6 comprising an erase period E(P), an address period P and a sustain period of weight 4; and finally

a seventh period P7 comprising an erase period E(P), an address period P and a sustain period of weight 1.

The period P7 of the video frame that precedes the current video frame is also shown in dotted lines in FIG. 3.

The overall time of the sustain periods in the video frame remains unchanged with respect to the video frame in FIG. 2. The same applies to the address and erase periods.

This novel way of splitting up the address periods and erase periods, together with the novel distribution of sustain periods, in the video frame makes it possible to obtain an arrangement of the subfields in the video frame or a temporal position of the video frame which is different for the odd rows and the even rows of the panel.

This is because, in this structure, each sustain period of the frame relates to two subfields of different weights, one relating to the display of the odd rows of the PDP and the other to the display of the even rows.

In the example of FIG. 3, as regards the display of the odd rows of the PDP, the periods P1, P2 and P3 constitute the subfields SF1, SF2 and SF3 of the video frame respectively and the periods P4, P5, P6 and P7 together form the subfield SF4 (the odd row cells are not erased at the start of the periods P5, P6 and P7).

As regards the display of the even rows of the PDP, the periods P4, P5 and P6 form the subfields SF1, SF2 and SF3 of the video frame respectively. The subfield SF4 is formed:

a) either by the period P7 of the current video frame and the periods P1, P2 and P3 of the next video frame;

b) or by the period P7 of the preceding video frame (in dotted lines) and the periods P1, P2 and P3 of the current video frame.

This results in two situations:

in case a), the subfields associated with the even rows of the PDP are displayed in the same order, namely SF1, then SF2, then SF3 and then SF4, as those associated with the odd rows of the PDP, but this display is offset by approximately one half the video frame with respect to the odd rows;

in case b), the subfields associated with the even rows are not displayed in the same order as those associated with the odd rows of the PDP, namely in the order (SF1, SF2, SF3, SF4) for the odd rows and in the order (SF4, SF1, SF2, SF3) for the even rows; in addition, the display of the even rows of the PDP are slightly offset with respect to the odd rows; the offset corresponds to the period P7.

In both cases, high-weight subfields of even rows are displayed during low-weight subfields of odd rows, and vice versa. This may therefore be referred to as an interlaced addressing or display mode. In case b), the high-weight subfields of even rows and the low-weight subfields of odd rows displayed simultaneously relate to the same image. This is not true in case a).

This interlaced mode amounts to simulating a 100 Hz display for the human eye. There is therefore no longer a problem of large-area flicker.

Moreover, this interlaced mode allows the current consumption of the PDP to be better distributed over the entire frame. FIG. 4, to be compared with FIG. 1, shows the current consumed by the PDP during a video frame when the display method of the invention is applied. As in FIG. 1, an image is considered to have an equiprobable distribution of possible grey levels (20% of the cells of the PDP have a 0 grey level; 20% of the cells are on only during the subfield SF1; 20% of the cells are on only during the subfields SF1 and SF2; 20% of the cells are on only during the subfields SF1, SF2 and SF3 and 20% of the cells are on during the four subfields SF1, SF2, SF3 and SF4). According to the invention, the intensity of the current to be delivered to the PDP does not exceed 50% of the maximum current intensity (the case in which all the cells of the PDP are on at the same time). This makes it possible to use a less expensive current supply, especially one with a discharge capacitor of lower capacitance.

However, this interlaced mode may generate a few display defects because of the offset between the video frame associated with the even rows of the PDP and that associated with the odd rows. Moreover, problems of contouring effects may also appear when the sequence of images to be displayed includes objects which move over several consecutive images. Advantageously, the subfields are then displaced spatially in the direction of movement depending on their temporal position in the video frame, in order to correct these defects.

To do this, the subfields of each image j are divided into two consecutive groups of subfields, a first group Lⱼ comprising the low-weight subfields and a group Hⱼ comprising the high-weight subfield or subfields. For example, if a video image comprising four subfields as in FIG. 3 is taken, the group Lⱼ comprises the subfields SF1, SF2 and SF3 and the group Hⱼ comprises the subfield SF4. These two groups have approximately equal durations. A movement vector M representative of the movement of the video image in question with respect to the preceding image is then calculated for each pixel of the video image to be displayed. Finally, at least one of the groups of subfields is shifted in the direction of the movement.

FIG. 4 illustrates the displacement of the subfields if the video image associated with the even rows of the PDP is offset by approximately one half frame with respect to that associated with the odd rows of the PDP (case a referred to previously). In this figure, the y-axis represents the time axis and the x-axis represents the pixels. On the x-axis, i denotes a pixel displayed on an even row of the PDP and p denotes a pixel displayed on an odd row of the PDP. The groups L₁ and H₁ represent the low-weight subfields and the high-weight subfields for an image 1, respectively. Likewise, the groups L₂ and H₂ represent the low-weight subfields and the high-weight subfields for an image 2, respectively. The groups of subfields L₁ and H₁ of the pixel i are displayed one after the other between the instants 0 and T and those of the pixel p are displayed between T/2 and 3T/2. T represents the duration of a video frame. According to the invention, the group H₁ of the pixel i and the group L₁ of the pixel p are offset by an amount equal to M/2. Moreover, the group H₁ of the pixel p is displaced by an amount equal to M. The final position of the groups of displaced subfields is shown by the dotted lines in the figure.

As a variant, the groups L₁ and H₁ of the pixel p could have been displayed between 0 and T and those of the pixel i between T/2 and 3T/2.

The group H₁ of the pixel p and the group L₁ of the pixel i would be offset by an amount equal to M/2 and the group H₁ of the pixel i would be displaced by an amount equal to M.

According to another variant, the compensation is limited to a displacement amplitude of at most M/2. The compensation is −M/2 for one group, 0 for two groups and M/2 for the last group, making an overall displacement of −M/2 in the above examples. This variant reduces the areas associated with movement compensation.

FIG. 6 illustrates the displacement of the subfields if the order of the subfields associated with the odd rows of the PDP is different from that associated with the even rows (case b referred to above). As in FIG. 4, the groups of subfields L₁ and H₁ of the pixel i are displayed in this order between the instants 0 and T. The groups of subfields L₁ and H₁ of the pixel p are also displayed between 0 and T, but in the reverse order (the group H₁ is displayed before the group L₁). In this particular case, only the group H₁ of the pixel i and the group L₁ of the pixel p are offset by an amount equal to M/2. This second situation limits the number of subfield displacements to be made.

As a variant, the groups L₁ and H₁ of the pixel p and the pixel i could have been displayed in the reverse order. The group H₁ of the pixel i and the group L₁ of the pixel p would be offset by an amount equal to M/2.

Very many structures for implementing the method of the invention are possible. One illustrative example is shown in FIG. 7. An image encoding unit 10 receives a flow of images. The function of this unit is to generate video frames according to the method of the invention. A movement compensation unit 11, for example a signal processor, then calculates the movement vectors to be associated with the various pixels of the image in question, offsets the groups of subfields as indicated above and delivers the address signals to the line driver 12 and the column driver 13 of a plasma tile 14. A synchronization circuit 15 is provided for synchronizing the drivers 12 and 13. This structure is given merely as an illustration.

The above modes of implementation relate to a splitting which permits sixteen grey levels. These examples were chosen to simplify the explanation. Transposition to 256 grey levels is automatic. If a binary decomposition is used, the splitting of the sustain periods shown in FIG. 8 is obtained.

Nor is it necessary to use binary splitting of the grey levels. To take an example, a more progressive code which reduces the contouring effects may be used. For example, FIG. 9 shows an example of splitting the sustain periods for the following illumination-weight decomposition: 1-2-4-7-11-16-22-30-40-54-72.

More generally, any type of grey-level encoding is possible provided that it is possible to split them into two groups of approximately equivalent weights.

What is claimed is:

1) Method of displaying a video image on a display device during a video frame, the said device comprising a plurality of cells arranged in rows and columns, the video frame being composed of a plurality of periods called subfields during which each elementary cell is either in the on state or in the off state for a time proportional to an illumination weight, each subfield comprising:
an odd or even address period for addressing the odd row cells or the even row cells, respectively;
at least one sustain period, common to all of the cells of the panel, during which the cells are on or off depending on the last addressing; and
an even or odd erase period in order to erase the state of the odd row cells and of the even row cells, respectively;
in which at least one subfield associated with the odd rows has at least two sustain periods separated by at least one even address period and/or one even erase period, and in which at least one subfield associated with the even rows has at least two sustain periods separated by at least one odd address period and/or one odd erase period, said method including a step for:
splitting, for the odd and even rows of the panel, the subfields into two groups of subfields, the first group comprising the low-weight subfields and the second group comprising the high-weight subfields, both groups having approximately equal durations;
wherein it further includes the following steps:
estimation of the movement of the current video image with respect to a previous video image so as to generate a movement vector for each pixel of the current video image; and
for each pixel of the current video image, displacement of the subfields of one of the groups for the even rows of the panel and of the subfields of the other of the groups for the odd rows by an amount approximately equal to half of the estimated movement vector.

2) Method according to claim 1, wherein the subfields of the video frame of the even rows of the panel are displayed in the same order as those of the odd rows of the panel, but are temporarily offset by approximately half a video frame with respect to the latter.

3) Method according to claim 2, characterized in that wherein,
for each pixel of the current video image, the subfields of the second group for the odd rows of the panel and the subfields of the first group for the even rows of the panel are displaced by an amount approximately equal to half of the estimated movement vector and the subfields of the second group for the even rows of the panel are displaced by an amount approximately equal to the estimated movement vector.

4) Method according to claim 2, wherein, for each pixel of the current video image, the subfields of the second group for the even rows of the panel and the subfields of the first group for the odd rows of the panel are displaced by an amount approximately equal to half of the estimated movement vector and the subfields of the second group for the odd rows of the panel are displaced by an amount approximately equal to the estimated movement vector.

5) Method according to claim 1, wherein, the high-weight subfields of the even rows of the panel are, for the same image, displayed during the low-weight subfields of the odd rows, and vice versa.

6) Method according to claim 5, wherein, for each pixel of the current video image, the subfields of the second group for the odd rows of the panel and the subfields of the first group for the even rows of the panel are displaced by an amount approximately equal to half of the estimated movement vector.

7) Method according to claim 5, wherein, for each pixel of the current video image, the subfields of the second group for the even rows of the panel and the subfields of the first group for the odd rows of the panel are displaced by an amount approximately equal to half of the estimated movement vector.

8) Plasma display panel, wherein it includes a device for implementing the display method according to claim 1.
